(19) United States
(12) Patent Application Publication
(10) Pub. No.: US 2008/0267564 A1
(43) Pub. Date: Oct. 30, 2008

(54) Optical Waveguide Structure Having Asymmetric Y-Shape and Transceiver for Bidirectional Optical Signal Transmission Using the Same

(75) Inventors: Jae-Ho Han, Seoul (KR); Sang-Gil Shin, Gyeonggi-do (KR); Sung-Wook Moon, Seoul (KR); Jung-Ho Choi, Gyeonggi-do (KR); Moti Margalit, Ceaserea (IL); Daphna Bortman-Aviv, Ceaserea (IL); Nikolai Berkovitch, Ceaserea (IL); Eitan Avni, Ceaserea (IL)

Correspondence Address: JONES DAY, 222 EAST 41ST ST, NEW YORK, NY, 10017, US

(73) Assignee: LS Cable Ltd.

(21) Appl. No.: 11/596,552

(22) PCT Filed: May 12, 2004
(86) PCT No.: PCT/KR2004/001102

§ 371 Date: Nov. 13, 2006

(51) Int. Cl. G02B 6/42

(52) U.S. Cl. 385/45

(57) ABSTRACT

Disclosed are an asymmetric Y-shaped optical waveguide structure and an optical transceiver using the structure. The asymmetric Y-shaped optical waveguide structure includes a main axis optical waveguide extended in a longitudinal direction; and a branch optical waveguide extended from an extension start point in the main axis optical waveguide in a longitudinal direction as much as a predetermined region and then diverged outside. The main axis optical waveguide and the branch optical waveguide have effective refractive indexes, the magnitude relation of which is reversed for optical signals having first and second wavelength range. The optical transceiver includes an asymmetric Y-shaped optical waveguide structure, an optical fiber optically coupled to the structure for transmitting/receiving of the bi-directional optical signal, a laser diode and a photodiode. Accordingly, it is possible to miniaturize the optical transceiver, reduce a packaging cost, and improve reliability of the optical transceiver.

### TECHNICAL FIELD

The present invention relates to an optical waveguide structure capable of bi-direction transmission of optical signals having different wavelength ranges, and an optical transceiver realized using the structure.

### BACKGROUND ART

Recently, an optical transmission technique gradually expands its application from a trunk line construction field to a subscriber line construction field. Accordingly, a bi-direction optical transceiver in which transmitting and receiving functions of optical signals having different wavelength ranges by using a feature of an optical fiber which enables bi-directional communication between a transmitter and a receiver are integrated in one device is widely used.

Generally, the conventional bi-directional optical transceiver includes an optical waveguide formed on a semiconductor substrate, a WDM (Wavelength Division Multiplexer) for selectively dividing optical signals having different wavelength ranges, a laser diode for generating an optical signal (or, a transmitting optical signal) by electric-to-optical conversion of an electric signal and then transmitting the optical signal to an optical fiber, and a photodiode for receiving an optical signal (or, a receiving optical signal) from the optical fiber and then generating an electric signal by means of optical-to-electric conversion. The transmitting optical signal is output from the laser diode and then input into the optical fiber through the optical waveguide structure and the WDM, while the receiving optical signal is input through the optical fiber from outside and then input to the photodiode through the optical waveguide structure and the WDM.

FIG. 1 concretely shows that a common bi-directional optical transceiver is connected to an optical fiber. Referring to FIG. 1, the conventional bi-directional optical transceiver includes a semiconductor substrate S, an optical fiber 10, a V-shaped groove 20 for mounting of the optical fiber 10, a WDM filter 30 for division of a transmitting optical signal and a receiving optical signal, an optical waveguide 40 for wave-guiding the transmitting and receiving optical signals, a laser diode 50 for transmitting an optical signal, and a photodiode 60 for receiving an optical signal.

The optical waveguide 40 has three coupling nodes. The first node A is optically coupled to the optical fiber 10, the second node B is optically coupled to the WDM filter 30, and the third node C is optically coupled to the laser diode 50. The WDM filter 30 reflects the transmitting optical signal, received through the third node C, at the second node B so as to be optically coupled to the optical fiber 10 through the first node A, and passes the receiving optical signal, received through the first node A, so as to be optically coupled to the photodiode 60.

However, the conventional bi-directional optical transceiver configured as mentioned above has structural instability since the optical waveguide 40 and the WDM filter 30 are independently configured. In addition, the conventional bi-directional optical transceiver suffers from high insertion loss caused by the multitude and complexity of the optical elements.

Furthermore, because accurate optical axis alignments are required at many points, such as between the optical waveguide 40 and the optical fiber 10, between the optical waveguide 40 and the WDM filter 30, between the WDM filter 30 and the photodiode 60, and between the optical waveguide 40 and the laser diode 50, module packaging cost will be high.

In addition, since an output direction of the transmitting optical signal in the laser diode 50 is approximately coincident with an input direction of the receiving optical signal in the photodiode 60, the conventional module cannot fundamentally prevent the crosstalk phenomenon if a leakage optical signal which is not optically coupled from the laser diode 50 to the optical waveguide is in existence.

### DISCLOSURE OF INVENTION

The present invention is designed to solve the problems of the prior art, and therefore it is an object of the present invention to provide an asymmetric Y-shaped optical waveguide structure capable of dividing a transmitting signal and a receiving signal, which have different wavelength ranges. The Y structure is realized in the optical waveguide structure and replaces the separate WDM filters.

Another object of the preset invention is to provide a bi-directional optical transceiver, which is provided with stability in the aspect of an optical axis alignment together with a simple internal configuration, and is capable of reducing a packaging cost according to the optical axis alignment, by having an asymmetric Y-shaped optical waveguide structure equipped with a wavelength division function in itself.

In order to accomplish the above object, the present invention provides an asymmetric Y-shaped optical waveguide structure including a main axis optical waveguide extended in a longitudinal direction; and a branch optical waveguide extended from an extension start point in the main axis optical waveguide in a longitudinal direction as much as a predetermined region and then diverged outside, wherein the main axis optical waveguide and the branch optical waveguide have effective refractive indexes, the magnitude relation of which is reversed for optical signals having a first wavelength range (e.g., 1550 nm) and a second wavelength range (e.g., 1310 nm).

According to an aspect of the invention, the main axis optical waveguide has a greater effective refractive index than the branch optical waveguide in the first wavelength range, and vice versa in the second wavelength range.

In this case, if an optical signal in the first wavelength range is received to one end of the main axis optical waveguide, the optical signal in the first wavelength range is guided to the other end of the main axis optical waveguide. Meanwhile, if an optical signal in the second wavelength range is input to the branch optical waveguide, the optical signal in the second wavelength range is guided to one end of the main axis optical waveguide through the extension start point.

According to another aspect of the invention, the branch optical waveguide has a greater effective refractive index than the main axis optical waveguide in the first wavelength range, and vice versa in the second wavelength range.

In this case, if an optical signal in the first wavelength range is received to one end of the main axis optical waveguide, the optical signal in the first wavelength range is guided to the branch optical waveguide through the extension start point. Meanwhile, if an optical signal in the second wavelength range is input to the other end of the main axis optical waveguide, the optical signal in the second wavelength range is guided to one end of the main axis optical waveguide.

Preferably, the main axis optical waveguide and the branch optical waveguide are surrounded by a clad layer. In addition, the branch optical waveguide preferably forms a smooth curve close to a straight line, which may prevent a dispersed light from being input to the photodiode.

Preferably, the branch optical waveguide is straightly extended in a predetermined region on the basis of the extension start point before being diverged from the main axis optical waveguide.

In order to accomplish the above object, in one aspect of the invention, the present invention also provides a bi-directional optical transceiver having an asymmetric Y-shaped optical waveguide structure in a clad layer deposited on a semiconductor substrate, which includes a main axis optical waveguide extended in a longitudinal direction; a branch optical waveguide extended from an extension start point in the main axis optical waveguide in a longitudinal direction as much as a predetermined region and then diverged outside; an optical fiber optically coupled to one end of the main axis optical waveguide so as to be capable of inputting an optical signal in a first wavelength range; a photodiode optically coupled to the other end of the main axis optical waveguide so as to be capable of optical-to-electric conversion of the optical signal in the first wavelength range; and a laser diode optically coupled to the branch optical waveguide so as to be capable of inputting an electric-to-optical converted optical signal in a second wavelength range to the branch optical waveguide, wherein the main axis optical waveguide has a greater effective refractive index than the branch optical waveguide in the first wavelength range, while the branch optical waveguide has a greater effective refractive index than the main axis optical waveguide in the second wavelength range.

According to another aspect of the invention, the present invention provides, in order to accomplish the above object, a bi-directional optical transceiver having an asymmetric Y-shaped optical waveguide structure in a clad layer deposited on a semiconductor substrate, which includes a main axis optical waveguide extended in a longitudinal direction; a branch optical waveguide extended from an extension start point in the main axis optical waveguide in a longitudinal direction as much as a predetermined region and then diverged outside; an optical fiber optically coupled to one end of the main axis optical waveguide so as to be capable of inputting an optical signal in a first wavelength range; a photodiode optically coupled the branch optical waveguide so as to be capable of optical-to-electric conversion of the optical signal in the first wavelength range; and a laser diode optically coupled to the other end of the main axis optical waveguide so as to be capable of inputting an electric-to-optical converted optical signal in a second wavelength range, wherein the branch optical waveguide has a greater effective refractive index than the main axis optical waveguide in the first wavelength range, while the main axis optical waveguide has a greater effective refractive index than the branch optical waveguide in the second wavelength range.

Preferably, a V-shaped groove for manual optical axis alignment of the optical fiber is formed in an upper surface of the semiconductor substrate.

Preferably, grooves are formed in an upper surface of the semiconductor substrate for surface mounting of the photodiode and the laser diode, and the photodiode and the laser diode are respectively mounted in each groove by means of a flip chip process.

Preferably, the bi-directional optical transceiver further includes a monitor photodiode for receiving a leakage optical signal of the laser diode at a rear end of the laser diode in order to monitor an optical signal output of the laser diode. In this case, a groove may be formed in an upper surface of the semiconductor substrate for surface mounting of the monitor photodiode, and the monitor photodiode may be surface-mounted in the groove by means of a flip chip process.

### BRIEF DESCRIPTION OF THE DRAWINGS

Other objects and aspects of the present invention will become apparent from the following description of embodiments with reference to the accompanying drawing in which:

FIG. 1 is a schematic plane view showing a conventional bi-directional optical transceiver;

FIG. 2a is a plane view showing an asymmetric Y-shaped optical waveguide structure according to an embodiment of the present invention;

FIG. 2b is a sectional view taken along A-A′ line of FIG. 2a;

FIG. 3 is a graph showing a change of effective refractive index of SiON and Si₃N₄ according to a wavelength;

FIG. 4 is a schematic view showing an optical waveguide feature of the asymmetric Y-shaped optical waveguide structure according to the present invention;

FIG. 5 is a graph showing a wavelength-selective optical waveguide feature of the asymmetric Y-shaped optical waveguide structure according to the present invention;

FIG. 6a is a schematic view showing a bi-directional optical signal transmission process of an asymmetric Y-shaped optical waveguide structure according to an embodiment of the present invention;

FIG. 6b is a schematic view showing a bi-directional optical signal transmission process of an asymmetric Y-shaped optical waveguide structure according to another embodiment of the present invention;

FIG. 7 is a flowchart for illustrating the manufacturing procedure of the asymmetric Y-shaped optical wavelength structure according to an embodiment of the present invention;

FIG. 8a is a plane view showing a bi-direction optical transceiver according to an embodiment of the present invention; and

FIG. 8b is a sectional view taken along B-B′ line of FIG. 8a.

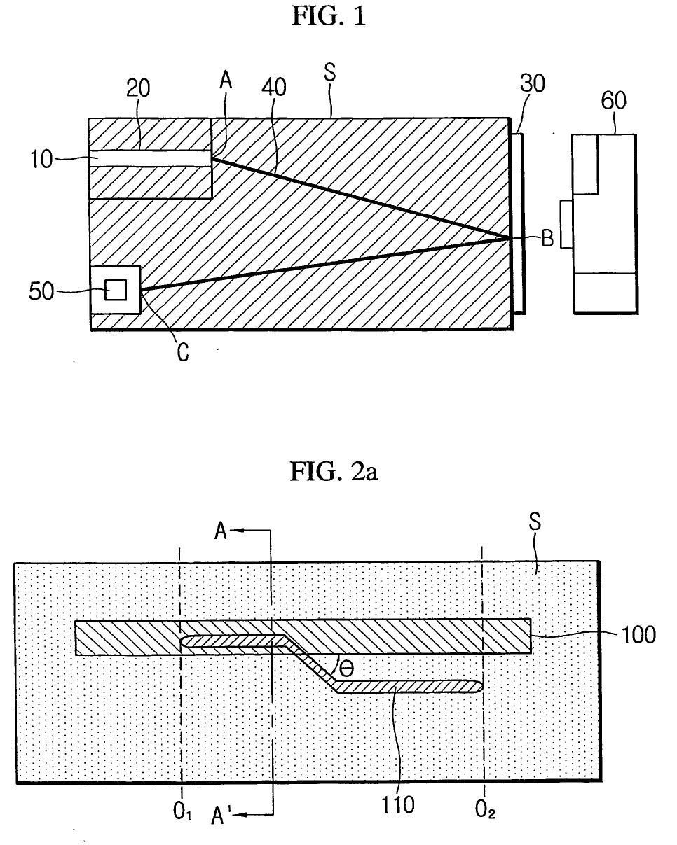

### BEST MODES FOR CARRYING OUT THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

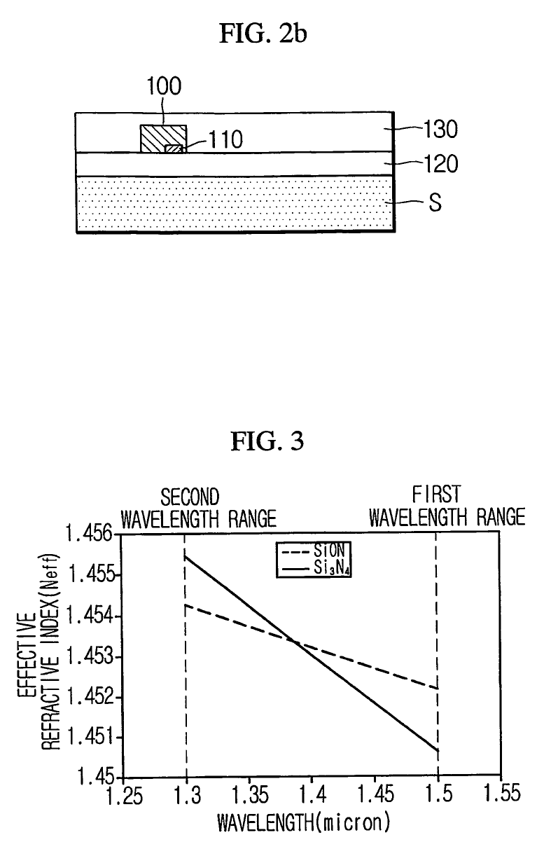

FIG. 2a is a plane view showing an upper surface of an PLC (Planar Lightwave Circuit) substrate having an asymmetric Y-shaped optical waveguide structure according to a preferred embodiment of the present invention, and FIG. 2b is a sectional view taken along A-A′ line of FIG. 2a.

Referring to FIGS. 2a and 2b, the asymmetric Y-shaped optical waveguide structure (hereinafter, referred to as ‘optical waveguide structure’) is formed on a silicon semiconductor substrate S, and has a main axis optical waveguide 100 and a branch optical waveguide 110.

The main axis optical waveguide 100 is extended in a longitudinal direction with forming a smooth curve close to a straight line. The branch optical waveguide 110 is extended in a longitudinal direction as much as a predetermined region from an extension start point O₁ in the main axis optical waveguide 100, and then diverged out of the 100 to an extension end point O₂ in a branch shape.

As mentioned above, since the branch optical waveguide 110 is diverged at a predetermined angle from the substantially straight main axis optical waveguide 100 to outside, the optical waveguide structure of the present invention has an asymmetric Y shape. The branch optical waveguide 110 preferably has a diverging angle θ of 7 to 15 miliradians on the basis of the main axis optical waveguide 100 in order to minimize a bending loss and a size of the optical transceiver.

Preferably, the main axis optical waveguide 100 has a width of 5 to 6 μm and a height of 1 to 2 μm, while the branch optical waveguide 110 has a width of 1 to 2 μm and a height of 0.07 to 0.1 μm, which enables single mode propagation.

The main axis optical waveguide 100 and the branch optical waveguide 110 diverged therefrom are surrounded by a clad layer 120 and 130. The clad layer 120 and 130 are classified into a lower clad layer 120 and an upper clad layer 130 on the basis of bottom surfaces of the main axis optical waveguide 100 and the branch optical waveguide 110. The clad layers 120 and 130 are made of transparent dielectric substances having a controlled refractive index so that an optical signal may be limitedly transferred through the internal region of the main axis optical waveguide 100 and the branch optical waveguide 110. Preferably, the clad layers 120 and 130 may be formed by SiO₂ having a controlled refractive index, but the present invention is not limited to that example.

The main axis optical waveguide 100 and the branch optical waveguide 110 are respectively made of first and second dielectric substances. Preferably, the first and second dielectric substances have different effective refractive indexes, the magnitude relation of which is reversed in a first wavelength range (e.g., 1550 nm) and a second wavelength range (e.g., 1310 nm). That is to say, it is possible that the main axis optical waveguide 100 has a greater effective refractive index than the branch optical waveguide 110 in the first wavelength range, and vice versa in the second wavelength range. As an alternative, it is also possible that the branch optical waveguide 110 has a greater effective refractive index than the main axis optical waveguide 100 in the first wavelength range, and vice versa in the second wavelength range.

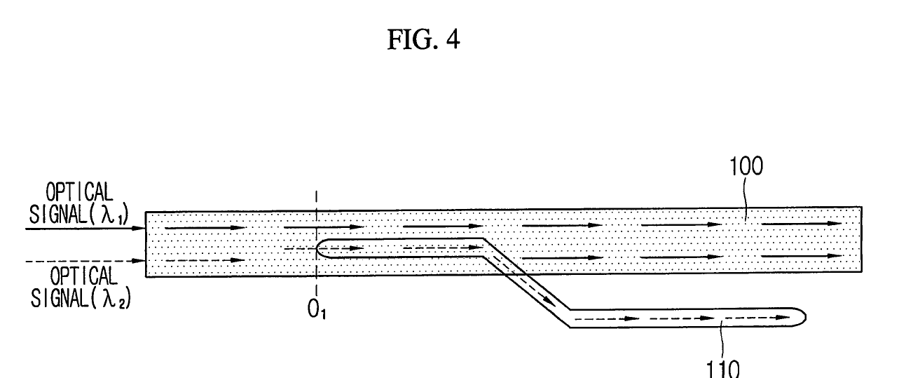

In the technical field of the present invention, it is easy to select the first and second dielectric substances so that the main axis optical waveguide 100 and the branch optical waveguide 110 meet such a refractive index condition. For example, if SiON (index=1.49) is selected for the first dielectric substance and Si₃N₄ (index=2) is selected for the second dielectric substance, the effective refractive index of the main axis optical waveguide 100 is greater than that of the branch optical waveguide 110 in the first wavelength range, and vice versa in the second wavelength range. Such an effective refractive index feature of SiON and Si₃N₄ changing according to the wavelength is shown in FIG. 3.

The present invention is based on adiabatic mode transition of the optical waveguide. Because of the adiabatic mode transition, an optical signal, when it meets a Y-shaped optical waveguide during the wave-guiding procedure, is wave-guided toward an optical waveguide having a relatively greater effective refractive index (refer to Willian K. Burns and A. Fenner Milton, IEEE J. Quantum Electron., vol. QE-16, no. 4, pp. 446-454, 1980).

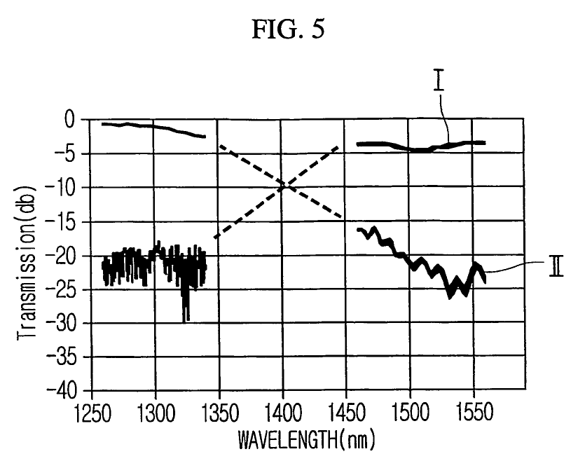

FIG. 4 conceptually depicts an optical waveguide feature of the optical waveguide structure according to the present invention. Referring to FIG. 4, if an optical signal (designated by a solid arrow) in the first wavelength range and an optical signal (designated by a dashed arrow) in the second wavelength range are input to the left end of the main axis optical wavelength 100 at the same time, the optical signals are selectively guided at the extension start point (O₁) of the branch optical wavelength 110 according to the wavelength range of each optical signal by means of the adiabatic mode transition. That is to say, each optical signal selects an optical waveguide having a relatively larger effective refractive index in its own wavelength range as a transmission medium, and is then guided thereto.

For example, if the main axis optical waveguide 100 has a greater effective refractive index than the branch optical waveguide 110 on the basis of the optical signal in the first wavelength range, the optical signal in the first wavelength range keeps to be wave-guided through the main axis optical waveguide 100. If the branch optical waveguide 110 has a greater effective refractive index than the main axis optical waveguide 100 on the basis of the optical signal in the second wavelength range, the optical signal in the second wavelength range changes an optical waveguide medium into the branch optical waveguide 110 and is then guided through the branch optical waveguide 110.

As mentioned above, optical signals having different wavelength ranges may be defined to separate optical waveguide on the basis of the extension start point O₁ of the branch optical waveguide 110, which means that the asymmetric Y-shaped optical waveguide structure according to the present invention has a wavelength division structure in itself.

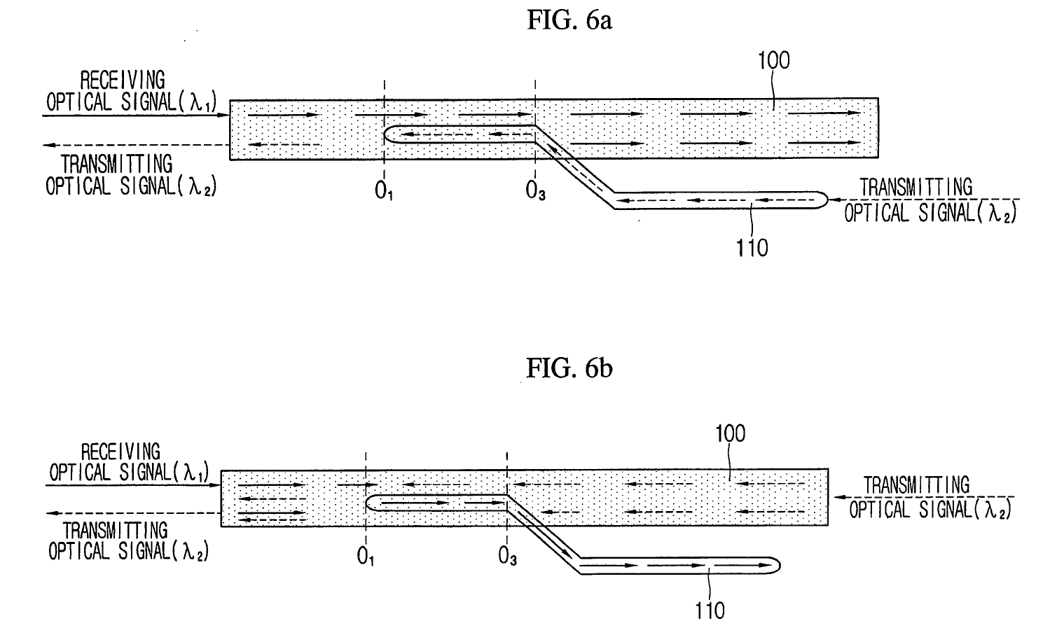

FIG. 5 shows a measurement result of intensities of optical signals output to a right end of the main axis optical waveguide 100 and a right end of the branch optical waveguide 110, in the case that the main axis optical waveguide 100 and the branch optical waveguide 110 are respectively made of SiON (index=1.49) and Si₃N₄ (index=2) and that optical signals having wavelength ranges of 1310 nm and 1550 nm are input to the left end of the main axis optical waveguide 100 with the use of tunable laser sources having wavelength ranges of 1310 nm and 1550 nm. In FIG. 5, ‘I’ is an intensity of the optical signal measured at the right end of the main axis optical waveguide 100, while ‘II’ is an intensity of the optical signal measured at the right end of the branch optical waveguide 110.

As shown in FIG. 5, it is found that the optical waveguide structure according to this embodiment approximately has a good wavelength division feature for optical signals at 1310 nm and 1550 nm. It suggests that the wavelength ranges of 1550 nm and 1310 nm are approximately preferable for bi-directional optical signal transmission in the optical waveguide structure according to this embodiment.

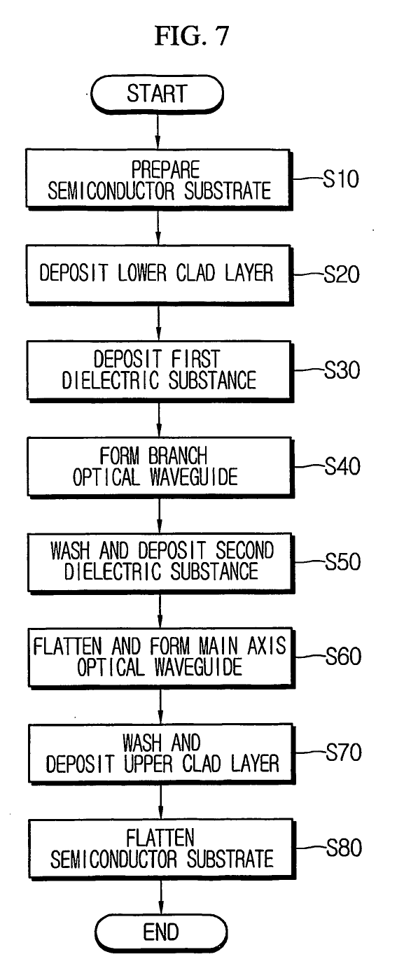

Owing to such a wavelength-selective optical waveguide feature mentioned above, the optical waveguide structure according to the present invention is capable of conducting transmitting/receiving operation of bi-directional optical signals, which is concretely described with reference to FIGS. 6a and 6b. In FIGS. 6a and 6b, a solid arrow designates an optical signal input from outside (hereinafter, referred to as ‘a receiving optical signal), while a dashed arrow designates an optical signal optically output to outside (hereinafter, referred to as ‘a transmitting optical signal’), on the basis of the left end of the main axis optical waveguide 100. At this time, the receiving optical signal is in the first wavelength range (e.g., 1550 nm), and the transmitting optical signal is in the second wavelength range (e.g., 1310 nm).

### <Condition 1>

a receiving optical signal in the first wavelength range: 1550 nm
a transmitting optical signal in the second wavelength range: 1310 nm
the main axis optical waveguide 100 has a greater effective refractive index than the branch optical waveguide 110 in the first wavelength range, and vice versa in the second wavelength range.
the receiving optical signal is input to the left end of the main axis optical waveguide 100.
the transmitting optical signal is input to the branch optical waveguide 110.

As shown in FIG. 6a, the receiving optical signal is substantially guided exclusively to the main axis optical waveguide 100 under the condition 1. Light is substantially guided only toward the main axis optical waveguide 100 since the main axis optical waveguide 100 has a greater effective refractive index than the branch optical waveguide 110 in the wavelength range of the receiving optical signal. Meanwhile, the transmitting optical signal is substantially transmitted limitedly to the branch optical waveguide 110, and is then guided to the left end of the main axis optical waveguide 100 through the extension start point O₁ of the branch optical waveguide 110. Since the adiabatic mode transition is negligible though the transmitting optical signal reaches the extension start point O₁, the light is scarcely guided in a right direction of the main axis optical waveguide 100.

### <Condition 2>

a receiving optical signal in the first wavelength range: 1550 nm
a transmitting optical signal in the second wavelength range: 1310 nm
the branch optical waveguide 110 has a greater refractive index than the main axis optical waveguide 100 in the first wavelength range, and vice versa in the second wavelength range.
the receiving optical signal is input to the left end of the main axis optical waveguide 100.
the transmitting optical signal is input to the right end of the main axis optical waveguide 100.

As shown in FIG. 6b, in case of the condition 2, the receiving optical signal is initially guided through the main axis optical waveguide 100. The receiving optical signal then starts being guided to the branch optical waveguide 110 at the extension start point O₁ of the branch optical waveguide 110 by means of the adiabatic mode transition, and is then substantially guided in the branch optical waveguide 110 from a point O₃ where a predetermined region of the branch optical waveguide 110 extended in a longitudinal direction from the extension start point ends. In addition, since the main axis optical waveguide 100 has a greater effective refractive index than the branch optical waveguide 110 in the second wavelength range, the transmitting optical signal is substantially guided to the left end of the main axis optical waveguide 100, and limited to the main axis optical waveguide 100.

In order to realize bi-directional transmitting/receiving of optical signals with the use of the optical waveguide structure according to the present invention, it is necessary to arrange an optical fiber, a photodiode and a laser diode in suitable positions on the semiconductor substrate. This will be described later in more detail in a section related to configuration of a bi-directional optical transceiver according to the present invention.

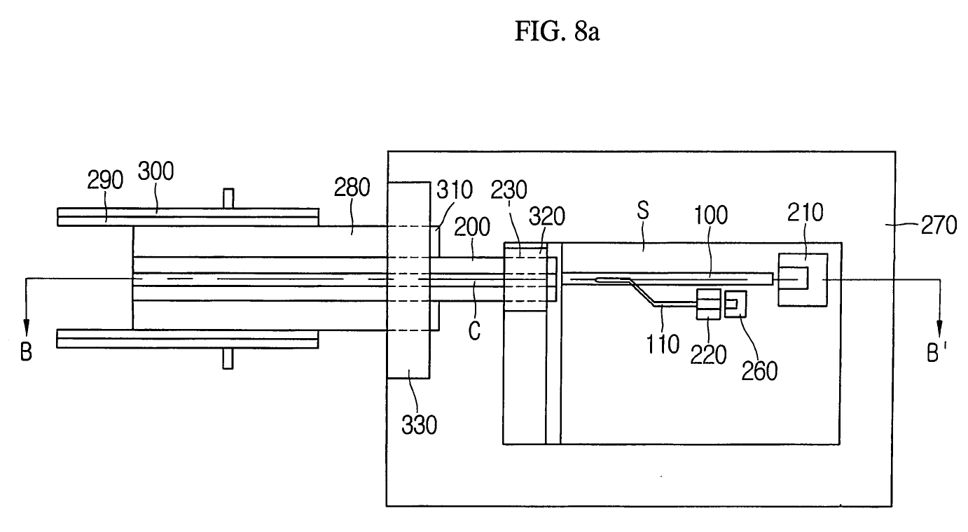

FIG. 7 is a flowchart for illustrating a manufacturing method for realizing the asymmetric Y-shaped optical waveguide structure according to an embodiment of the present invention.

Referring to FIG. 7, at first a silicon semiconductor substrate is prepared (S10). Then, a lower clad layer having a predetermined refractive index feature is deposited on the silicon semiconductor substrate (S20). Subsequently, a first dielectric substance having a predetermined refractive index feature is deposited on the lower clad layer in order to form a branch optical waveguide (S30). Then, the deposited first dielectric substance is patterned by means of photolithography to make the branch optical waveguide in a predetermined length (S40). And then, a washing process is conducted to eliminate impurities generated during an etching process, and a second dielectric substance having a predetermined refractive index feature is deposited on the patterned branch optical waveguide in order to form a main axis optical waveguide (S50). After that, the entire surface of the semiconductor substrate is flattened by means of a wide flattening process, and then the second dielectric substance deposited using the photolithography is patterned to form the main axis optical waveguide (S60). Then, a washing process is conducted to eliminate impurities caused in the etching process, and an upper clad layer having a predetermined refractive index feature is deposited on the entire surface of the semiconductor substrate (S70). After that, a wide flattening process is applied to flatten the entire surface of the semiconductor substrate, thereby completing an asymmetric Y-shaped optical waveguide structure on the semiconductor substrate (S80).

When configuring the optical waveguide structure on the semiconductor substrate as mentioned above, materials of the upper and lower clad layers, refractive index features, specific material and kinds of the first and second dielectric substances are defined in advance by a designer of the optical waveguide on the consideration of the aforementioned technical spirit of the present invention.

The upper and lower clad layers and the first and second dielectric substances may be deposited with the use of a known deposition process used in a general optical waveguide manufacturing method. In particular, since the branch optical waveguide is already formed on the semiconductor substrate before the second dielectric substance is deposited, the second dielectric substance is preferably deposited using a deposition technology giving an excellent step coverage feature. For example, the second dielectric substance may be deposited by means of CVD (Chemical Vapor Deposition).

Now, configuration of a bi-directional optical transceiver having the aforementioned asymmetric Y-shaped optical waveguide structure according to a preferred embodiment of the present invention is described in detail.

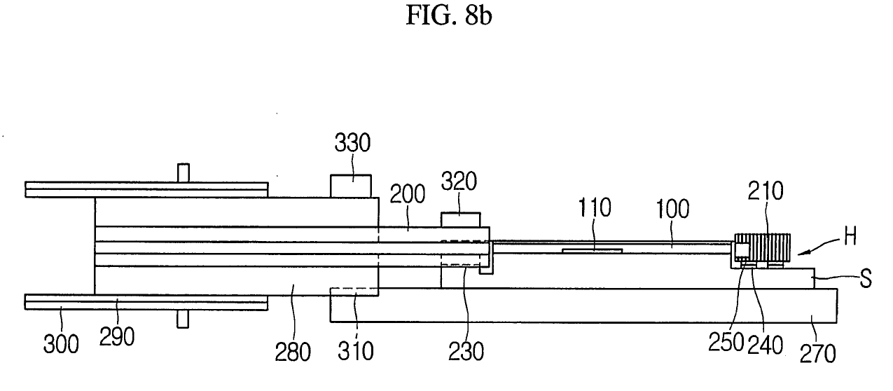

FIG. 8a is a plane view showing the optical transceiver according to a preferred embodiment of the present invention, and FIG. 8b is a sectional view taken along B-B′ line of FIG. 8a. The optical waveguide structure adopted in the optical transceiver has an optical signal guiding characteristic as shown in FIG. 6a. However, the present invention is not limited to that case, and the optical waveguide structure may have an optical signal guiding characteristic as shown in FIG. 6b.

Referring to FIGS. 8a and 8b concretely, the optical transceiver of the present invention includes an asymmetric Y-shaped optical waveguide structure composed of the main axis optical waveguide 100 and the branch optical waveguide 110, which are already described, an optical fiber 200 for optically coupling and inputting a receiving optical signal in the first wavelength range to one side of the main axis optical waveguide 100, a photodiode 210 for receiving the receiving optical signal guided through the main axis optical waveguide 100 and then generating an electric signal by means of optical-to-electric conversion, and a laser diode 220 for generating a transmitting optical signal by means of electric-to-optical conversion of an electric signal and then optically coupling and inputting the transmitting optical signal to the branch optical waveguide 110.

On the semiconductor substrate S having the optical waveguide structure, a V-shaped groove 230 is provided at a position where the optical fiber 200 is to be mounted. The optical fiber 200 is guided by means of the V-shaped groove 230, thereby being manually optically arranged with the main axis optical waveguide 100. For this purpose, it is preferred to precisely control width and depth of the V-shaped groove 230 on the consideration of optical axis alignment between a core C of the optical fiber 200 and the main axis optical waveguide 100.

The V-shaped groove 230 may be formed by forming the optical waveguide structure on the semiconductor substrate S and then etching corresponding regions on the semiconductor substrate S by means of the photolithography. At this time, since the V-shaped groove 230 should have slopes on both sides, an etching process having anisotropy is preferably applied. Of course, the V-shaped groove 230 may also be formed by other processes such as mechanical grinding, other than the photolithography.

On the semiconductor substrate S, a PD mounting groove (see ‘H’ in FIG. 8b) and an LD mounting groove (not shown) for mounting of the photodiode 210 and the laser diode 220 are further provided in addition to the V-shaped groove 230 for the optical fiber 200. Though FIG. 8b shows only the PD mounting groove, the LD mounting groove basically has a similar shape to the PD groove, with different width and depth.

The PD and LD mounting grooves may be made by forming the optical waveguide structure on the semiconductor substrate S and then conducting the photolithography. At this time, since the PD and LD mounting grooves preferably have slopes in their sides, it is desired to apply an etching process having anisotropy.

Preferably, the photodiode 210 and the laser diode 220 are surface-mounted respectively in the PD and LD mounting grooves by means of a flip chip process. For this purpose, patterned solder pads 240 used in executing the flip chip process are further provided to the PD and LD mounting grooves. In this case, the photodiode 210 and the laser diode 220 are firmly fixed by means of a flip chip bonding using solder bumps 250. At this time, if an amount of the solder bumps 250 is controlled, heights of the photodiode 210 and the laser diode 220 may be precisely controlled. Thus, if the flip chip process is applied, reliable optical axis alignment between the optical waveguide and the photodiode 210 and between the optical waveguide and the laser diode 220 may be easily obtained.

While the PD and LD mounting grooves are formed, their depth and width are preferably precisely controlled with synthetically considering sizes of the photodiode 210 and the laser diode 220, optical axis alignment between the diodes 210 and 220 and the optical waveguide, and heights of the solder pad 240 and the solder bump 250.

The optical transceiver of the present invention may further include a monitor photodiode 260 for receiving a leakage transmitting optical signal output from the rear surface of the laser diode 220 and then outputting an output level of the transmitting optical signal as an electric signal by means of optical-to-electric conversion in order to uniformly keep the output level of the transmitting optical signal output from the laser diode 220.

In this case, a monitor PD mounting groove (not shown) for mounting of the monitor photodiode 260 is preferably further provided on the semiconductor substrate S. The monitor photodiode 260 is preferably surface-mounted in the monitor PD mounting groove by means of a flip chip process. Though the monitor PD mounting groove is not definitely shown in FIG. 8b, its shape is very similar to the PD mounting groove.

In order to surface-mount the monitor photodiode 260 in the monitor PD mounting groove, a patterned solder pad is preferably formed in the monitor PD mounting groove. Width and depth of the monitor PD groove are preferably precisely controlled on the consideration of sizes of the monitor photodiode 260, optical axis alignment between the laser diode 220 and the monitor photodiode 260, and heights of the solder pad and the solder bump.

On the while, though not shown in the figures, an electrode pad for applying an electric signal for electric-to-optical conversion from an external circuit board to the laser diode 220, an electrode pad for inputting an electric signal, generated by optical-to-electric conversion of the photodiode 210, to an external circuit board, and an electrode pad for inputting an electric signal, generated by optical-to-electric conversion of the monitor photodiode 260, to an external circuit board may be further provided on the semiconductor substrate S, by means of wire bonding.

In the optical transceiver of the present invention, the semiconductor substrate S having the asymmetric Y-shaped optical waveguide structure and an optical activating element mounted therein is mounted on a ceramic substrate 270 having a predetermined thickness. Before optical axis alignment between the optical fiber 200 and the main axis optical waveguide 100 is manually conducted by guiding one end of the optical fiber 200 in the V-shaped groove 230, the other end of the optical fiber 200 is inserted into a ceramic ferrule 280 and then fixed by epoxy. And then, the ferrule 280 is grinded to expose the other end of the optical fiber 200, and the grinded ferrule 280 is again inserted into a sleeve 290 and then firmly fixed to a ferrule housing 300.

After the ferrule 280 is combined to the ferrule housing 300, one end of the ferrule 280 is mounted in a mounting groove 310 formed in the ceramic substrate 270, and one end of the optical fiber 200 is mounted in the V-shaped groove 230 for the purpose of optical axial alignment with the main axis optical waveguide 100. After that, the optical fiber 200 and the ferrule 280 are respectively covered by a glass cover 320 and a ferrule cover 330, and then by using epoxy, the ferrule 280 is firmly combined to the ceramic substrate 270 and the optical fiber 200 is firmly combined to the semiconductor substrate S. Then, the optical fiber 200 becomes optical-axially arranged with the main axis optical waveguide 100 in a state of being connectable through the ferrule 280 to an external optical fiber which transmits a receiving optical signal from a subscriber end.

On the other hand, the optical transceiver according to the present invention adopts an optical waveguide structure having the optical waveguide feature shown in FIG. 6a. However, if an optical waveguide structure having the optical waveguide feature shown in FIG. 6b is included in the optical transceiver, it is apparent that arrangement of the laser diode, the monitor photodiode and the photodiode should be changed accordingly.

Now, operation of the bi-directional optical transceiver according to the present invention is described in detail with reference to FIG. 8a.

A receiving optical signal in the first wavelength range received through the optical fiber 200 is optically coupled and input to one side of the main axis optical waveguide 100, and then wave-guided to the other end of the main axis optical waveguide 100. At this time, the receiving optical signal in the first wavelength range is not wave-guided to the branch optical waveguide 110. The wave-guided receiving optical signal is input to an optical activating unit of the photodiode 210, then converted into an electric signal by means of optical-to-electric conversion, and then output to an external circuit board.

Meanwhile, an electric signal applied to the laser diode 220 from an external circuit board is converted into a transmitting optical signal in the second wavelength range by means of electric-to-optical conversion, and then optically coupled and input to the branch optical waveguide 110. The input transmitting optical signal is wave-guided to the main axis optical waveguide 100 through an interface between the waveguides 100 and 110 formed at the extension start point O₁, and then optically coupled and input to the optical fiber 200.

As mentioned above, the bi-directional optical transceiver according to the present invention enables wavelength-selective waveguide in the optical waveguide structure without any separate WDM filter, thereby realizing bi-directional transmitting/receiving of optical signals under a simple and stable configuration.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to an aspect of the present invention, time and cost required for a packaging process of the optical transceiver may be reduced since the bi-direction optical transceiver of the present invention enables wavelength-selective optical signal waveguide in the optical waveguide structure without a separate WDM filter, which is adopted in the conventional optical transceiver.

According to another aspect of the present invention, since an optical signal transmission route for the optical transmitting/receiving operation is simple, the optical transceiver may be miniaturized, and an error of the optical axis alignment in the packaging process is reduced, thereby ensuring high reliability of the optical transceiver.

According to still another aspect of the present invention, since a wave-guiding route of the receiving optical signal is formed straightly, it is possible to give structural stability of the optical transceiver.

According to further another aspect of the present invention, since a transmitting optical signal output direction of the laser diode is not coincident to a receiving optical signal input direction of the photodiode, reliability deterioration of the optical transceiver caused by the crosstalk phenomenon may be effectively prevented.

What is claimed is:

1. An asymmetric Y-shaped optical waveguide structure comprising:
a main axis optical waveguide extended in a longitudinal direction; and
a branch optical waveguide extended from an extension start point in the main axis optical waveguide in a longitudinal direction as much as a predetermined region and then diverged outside,
wherein the main axis optical waveguide and the branch optical waveguide have effective refractive indexes, the magnitude relation of which is reversed for optical signals having a first wavelength range and a second wavelength range.

2. An asymmetric Y-shaped optical waveguide structure according to claim 1,
wherein the main axis optical waveguide has a greater effective refractive index than the branch optical waveguide in the first wavelength range, and vice versa in the second wavelength range.

3. An asymmetric Y-shaped optical waveguide structure according to claim 2,
wherein the main axis optical waveguide receives an optical signal in the first wavelength range at one side thereof and then wave-guides the optical signal toward the other side, and
wherein the branch optical waveguide receives an optical signal in the second wavelength range and then wave-guides the optical signal toward the extension start point.

4. An asymmetric Y-shaped optical waveguide structure according to claim 1,
wherein the branch optical waveguide has a greater effective refractive index than the main axis optical waveguide in the first wavelength range, and vice versa in the second wavelength range.

5. An asymmetric Y-shaped optical waveguide structure according to claim 4,
wherein the main axis optical waveguide receives an optical signal in the second wavelength range at one side thereof and then wave-guides the optical signal toward the other side thereof, while the main axis optical waveguide receives an optical signal in the first wavelength range at the other side thereof and then wave-guides the optical signal toward the branch optical waveguide, and
wherein the branch optical waveguide wave-guides the optical signal in the first wavelength range toward an extension end point.

6. An asymmetric Y-shaped optical waveguide structure according to any of claims 2 to 5,
wherein the main axis optical waveguide and the branch optical waveguide are surrounded by a clad layer.

7. An asymmetric Y-shaped optical waveguide structure according to claim 6,
wherein the clad layer is classified into upper and lower clad layers on the basis of bottom surfaces of the main axis optical waveguide and the branch optical waveguide.

8. An asymmetric Y-shaped optical waveguide structure according to claim 6,
wherein the branch optical waveguide is straightly extended in a predetermined region on the basis of the extension start point before being diverged from the main axis optical waveguide.

9. A bi-directional optical transceiver having an asymmetric Y-shaped optical waveguide structure in a clad layer deposited on a semiconductor substrate, comprising:
a main axis optical waveguide extended in a longitudinal direction;
a branch optical waveguide extended from an extension start point in the main axis optical waveguide in a longitudinal direction as much as a predetermined region and then diverged outside;
an optical fiber optically coupled to one end of the main axis optical waveguide so as to be capable of inputting an optical signal in a first wavelength range;
a photodiode optically coupled to the other end of the main axis optical waveguide so as to be capable of optical-to-electric conversion of the optical signal in the first wavelength range; and
a laser diode optically coupled to the branch optical waveguide so as to be capable of inputting an electric-to-optical converted optical signal in a second wavelength range to the branch optical waveguide,
wherein the main axis optical waveguide has a greater effective refractive index than the branch optical waveguide in the first wavelength range, while the branch optical waveguide has a greater effective refractive index than the main axis optical waveguide in the second wavelength range.

10. A bi-directional optical transceiver according to claim 9,
wherein a V-shaped groove for manual optical axis alignment of the optical fiber is formed in an upper surface of the semiconductor substrate.

11. A bi-directional optical transceiver according to claim 9,
wherein grooves are formed in an upper surface of the semiconductor substrate for surface mounting of the photodiode and the laser diode, and
wherein the photodiode and the laser diode are respectively mounted in each groove by means of a flip chip process.

12. A bi-directional optical transceiver according to claim 9, further comprising a monitor photodiode for receiving a leakage optical signal of the laser diode at a rear end of the laser diode in order to monitor an optical output,
wherein a groove is formed in an upper surface of the semiconductor substrate for surface mounting of the monitor photodiode, and the monitor photodiode is surface-mounted in the groove by means of a flip chip process.

13. A bi-directional optical transceiver according to any of claims 9 to 12,
wherein the main axis optical waveguide forms a smooth curve close to a straight line.

14. A bi-directional optical transceiver according to any of claims 9 to 12,
wherein the branch optical waveguide is straightly extended in a predetermined region on the basis of the extension start point before being diverged from the main axis optical waveguide.

15. A bi-directional optical transceiver having an asymmetric Y-shaped optical waveguide structure in a clad layer deposited on a semiconductor substrate, comprising:
a main axis optical waveguide extended in a longitudinal direction;
a branch optical waveguide extended from an extension start point in the main axis optical waveguide in a longitudinal direction as much as a predetermined region and then diverged outside;
an optical fiber optically coupled to one end of the main axis optical waveguide so as to be capable of inputting an optical signal in a first wavelength range;
a photodiode optically coupled the branch optical waveguide so as to be capable of optical-to-electric conversion of the optical signal in the first wavelength range; and
a laser diode optically coupled to the other end of the main axis optical waveguide so as to be capable of inputting an electric-to-optical converted optical signal in a second wavelength range,
wherein the branch optical waveguide has a greater effective refractive index than the main axis optical waveguide in the first wavelength range, while the main axis optical waveguide has a greater effective refractive index than the branch optical waveguide in the second wavelength range.

16. A bi-directional optical transceiver according to claim 15,
wherein a V-shaped groove for manual optical axis alignment of the optical fiber is formed in an upper surface of the semiconductor substrate.

17. A bi-directional optical transceiver according to claim 15,
wherein grooves are formed in an upper surface of the semiconductor substrate for surface mounting of the photodiode and the laser diode, and
wherein the photodiode and the laser diode are respectively mounted in each groove by means of a flip chip process.

18. A bi-directional optical transceiver according to claim 15, further comprising a monitor photodiode for receiving a leakage optical signal of the laser diode at a rear end of the laser diode in order to monitor an optical output,
wherein a groove is formed in an upper surface of the semiconductor substrate for surface mounting of the monitor photodiode, and the monitor photodiode is surface-mounted in the groove by means of a flip chip process.

19. A bi-directional optical transceiver according to any of claims 15 to 18,
wherein the main axis optical waveguide is substantially straight.

20. A bi-directional optical transceiver according to any of claims 15 to 18,
wherein the branch optical waveguide is straightly extended in a predetermined region on the basis of the extension start point before being diverged from the main axis optical waveguide.
